(19) United States
(12) Patent Application Publication
(10) Pub. No.: US 2025/0150677 A1
(43) Pub. Date: May 8, 2025

(54) LIVE BROADCAST METHOD, COMPUTER AND STORAGE MEDIUM

(71) Applicants: GUANGZHOU HUADUO NETWORK TECHNOLOGY CO., LTD., Guangzhou (CN); Guangzhou Overseas Kangbazi Network Technology Co., Ltd., Guangzhou (CN)

(72) Inventors: Xuhong Lin, Guangzhou (CN); Yingqi Wang, Guangzhou (CN); Changjun Dai, Guangzhou (CN)

(21) Appl. No.: 19/011,882

(22) Filed: Jan. 7, 2025

(30) Foreign Application Priority Data
Mar. 8, 2024 (CN) 20241027553.7

(51) Int. Cl. H04N 21/475; H04N 21/2187; H04N 21/462

(52) U.S. Cl. CPC H04N 21/475; H04N 21/2187; H04N 21/462

(57) ABSTRACT

A live broadcast method is provided by present disclosure. The method includes obtaining a live broadcast text and generating a live audio based on the live broadcast text, and determining a first live video that is time-aligned with the live audio and obtaining a second live video; playing the second live video in a live broadcast room; pausing the second live video in response that an audience in the live broadcast room asking a question, and playing a first response video that replies to the question; and continuing to play the second live broadcast video in response that all questions from the audience in the live broadcast room have been answered.

### FIELD

The subject matter herein generally relates to a field of e-commerce technology, and in particular to a live broadcast method, a computer and a storage medium.

### BACKGROUND

With rapid development of technology, people are increasingly keen to enrich their leisure time by watching live broadcasts. A live broadcast is very popular among current young generation and has become a popular form of entertainment. A virtual anchor may overcome some of real physiological limitation of a real anchor, such as not feeling tired or emotionally unstable. Therefore, the virtual anchor may become a tireless anchor in a live broadcast room and may continuously provide exciting content.

In traditional technology, the virtual anchor is mainly played by a 3D character, but it is limited by technology. There is a significant gap in expression and action reproduction compared with the real anchor, and picture quality and image of the 3D character is also significantly different from the real anchor. An audience may often figure out the difference between the real anchor and the virtual anchor at a first sight.

### BRIEF DESCRIPTION OF THE DRAWINGS

The above and/or additional aspects and advantages of the present application will become apparent and easily understood from the description of the embodiments below in conjunction with the accompanying drawings.

FIG. 1 is a flowchart of an embodiment of a live broadcast method provided in an embodiment of the present disclosure.

FIG. 2 is a flowchart of an embodiment of a method for generating a second live video provided in an embodiment of the present disclosure.

FIG. 3 is a flowchart of an embodiment of a method for generating a first response video based on a target response provided in an embodiment of the present disclosure.

FIG. 4 is a flowchart of an embodiment of a method for generating a first response video based on a manual response provided in an embodiment of the present disclosure.

FIG. 5 is a flowchart of an embodiment of a method for determining whether a chat text is a question text provided in an embodiment of the present disclosure.

FIG. 6 is a flowchart of an embodiment of a method for generating an audio drive video corresponding to various speech provided in an embodiment of the present disclosure.

FIG. 7 is a flowchart of an embodiment of a method for playing an audio drive video corresponding to various speech provided in an embodiment of the present disclosure.

FIG. 8 is a block diagram of a digital human live broadcast apparatus provided in an embodiment of the present disclosure.

FIG. 9 is a structural diagram of a computer provided in an embodiment of the present disclosure.

### DETAILED DESCRIPTION

An embodiment of the present disclosure is described in detail below, and an example of the embodiment is shown in the accompanying drawings, where the same or similar reference numerals throughout represent the same or similar elements or elements having the same or similar functions. The embodiment described below with reference to accompanying drawings is exemplary and is only used to explain the present disclosure and may not be interpreted as limiting the present disclosure.

It will be understood by those skilled in the art that, unless expressly stated, the singular forms “one”, “said”, and “the” used herein may also include plural forms. It should be further understood that the term “comprising” used in the specification of the present disclosure refers to the presence of the features, integers, steps, operations, elements and/or components, but does not exclude the presence or addition of one or more other features, integers, steps, operations, elements, components and/or groups thereof. It should be understood that when we refer to an element as being “connected” or “coupled” to another element, it may be directly connected or coupled to the other element, or there may be an intermediate element. In addition, the “connection” or “coupled” used herein may include wireless connection or wireless coupled. The term “and/or” used herein includes all or any unit and all combinations of one or more associated listed items.

It will be understood by those skilled in the art that, unless otherwise defined, all terms (including technical and scientific terms) used herein have the same meaning as generally understood by those skilled in the art to which this disclosure belongs. It should also be understood that terms such as those defined in common dictionaries should be understood to have meanings consistent with the meanings in the context of the prior art and will not be interpreted with idealized or overly formal meanings unless specifically defined as here.

It will be understood by those skilled in the art that the “client”, “terminal” and “terminal device” used herein include both devices with wireless signal receivers, which are devices with only wireless signal receivers without transmission capabilities, and devices with receiving and transmitting hardware, which are devices with receiving and transmitting hardware capable of two-way communication on a two-way communication link. Such a device may include a cellular or other communication device such as a personal computer, a tablet computer. The device has a single-line display or a multi-line display or a cellular or other communication device without multi-line displays. The device may be a personal communication system (PCS), which may combine voice, data processing, fax and/or data communication capabilities. The device may be a personal digital assistant (PDA), which may include a radio frequency receiver, a pager, Internet access, a web browser, a notepad, a calendar and/or a global positioning system (GPS) receiver. The device may be a conventional laptop and/or a palmtop computer or other device with and/or including a radio frequency receiver. The “client”, “terminal” and “terminal device” used herein may be portable, transportable, installed in a vehicle (air, sea and/or land), or suitable for and/or configured to run locally, and/or in a distributed form, at any other location on the earth and/or in space. The “client”, “terminal” and “terminal device” used herein may also be a communication terminal, an Internet terminal, a music/video playing terminal, for example, a PDA, a Mobile Internet Device (MID) and/or a mobile phone with a music/video playing function, or a smart TV, a set-top box and other devices.

The hardware referred to by the names such as “server”, “client”, and “service node” in this disclosure is essentially an electronic device with the equivalent capabilities of a personal computer. It is a hardware device with the necessary components revealed by the von Neumann principle, such as a central processing unit (including an arithmetic unit and a controller), a memory, an input device, and an output device. The computer program is stored in its memory, and the central processing unit invokes the program stored in the external memory into the internal memory for execution, executes the instructions in the program, and interacts with the input and output devices to complete specific functions.

The hardware referred to in the names “server”, “client”, “service node”, etc., referred to in the present disclosure is essentially an electronic device with the equivalent capability of a personal computer, and is a hardware device with the necessary components revealed by von Neumann's principle, such as a central processing unit (including a combinator and a controller), memory, input devices, and output devices, and the computer program is stored in its memory, and the central processing unit calls the program stored in the external memory into the memory to run, executes the instructions in the program, and interacts with the input and output devices. This accomplishes a specific function.

It should be noted that “server” referred to in the present disclosure may also be extended to the situation of server fleets. According to the principle of network deployment as understood by those skilled in the art, the servers shall be logically divided, and in the physical space, these servers may be independent of each other but may be called through interfaces, or may be integrated into a physical computer or a set of computer fleets. Those skilled in the art should understand this adaptation and should not constrain the implementation of the network deployment mode of the present disclosure.

One or more of the technical features of the present disclosure, unless expressly specified, may be deployed on the server and the client remotely calls the online service interface provided by the server to implement the access, or may be directly deployed and run on the client to implement the access.

Unless expressly specified, the various data involved in the present disclosure may be stored either remotely on a server or on a local terminal device, as long as it is suitable for being called by the technical solution of the present disclosure.

Those skilled in the art should be aware that although the various methods of the present disclosure are described on the basis of the same concept and appear common to each other, they may be performed independently unless otherwise specified. Similarly, for each embodiment revealed in the present disclosure, which is based on the same inventive idea, the concepts of the same expression, and therefore the concepts of the same expression, and the concepts that are appropriately transformed for convenience only, despite the different conceptual expressions, should be understood equally.

Unless the mutually exclusive relationship between the embodiments to be revealed in the present disclosure is expressly indicated, the relevant technical features involved in each embodiment may be cross-combined to flexibly construct new embodiments, provided that such combination does not deviate from the creative spirit of the present disclosure and may meet the needs in the prior art or solve the deficiencies in some aspects of the prior art. Those skilled in the art should be aware of this adaptation.

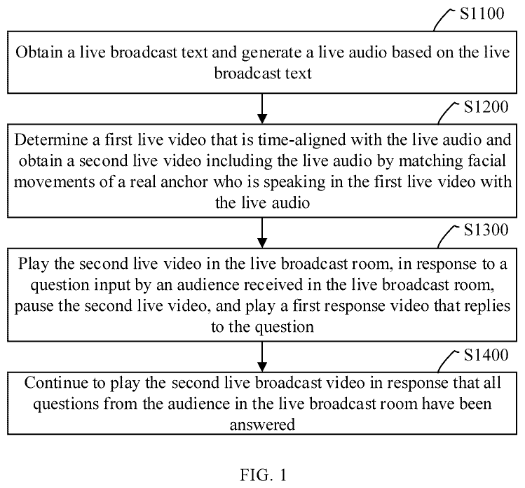

Please refer to FIG. 1, the present disclosure provides a live broadcast method, in at least one embodiment, the live broadcast method includes the following steps:

Step S1100, a computer obtains a live broadcast text and generates a live audio based on the live broadcast text.

In one embodiment, content of the live broadcast text is used to attract an audience, introduce a product or service, and promote interaction between a real anchor and an audience during a live broadcast. The live broadcast text may include any one or more of the contents such as an introduction of the live broadcast, features of the product, promotional information, an interactive link, and so on for attracting attention of the audience and guide the audience to participate in the interaction or purchase the product. The live broadcast text is usually edited by a copywriter or the real anchor himself before broadcasting live stream.

In one embodiment, the computer receives the live broadcast text submitted by an editor who edited the live broadcast text, and then uses a preset speech synthesis model to generate speech of the live broadcast text as the live audio. The speech synthesis model is pre-trained to a convergence state and learns the ability to convert a text that is input into a speech with a specified timbre. Those skilled in the art may flexibly implement the training of the speech synthesis model and may also set the specified timbre as needed. The speech synthesis model may be any one of Tacotron2, GST, Deep Voice3, ClariNet, LPCNet, Transformer-TTS, Glow-TTS, Flow-TTS, cVAE+Flow+GAN, PnG BERT, etc. Specifically, in one embodiment, the FastSpeech2 model is used as an acoustic model, the WaveNet model is used as a vocoder, and the vocoder is connected to the acoustic model to form the speech synthesis model. The live broadcast text is preprocessed, which includes regularizing and segmenting the live broadcast text. Regularizing the live broadcast text includes removing irrelevant information such as noise, a HTML tag and a punctuation mark from the live broadcast text, and uppercase and lowercase conversion of the live broadcast text. Different segmentation algorithms and tools, such as rule-based segmentation, statistical segmentation, deep learning-based segmentation model, N-gram segmentation tool, jieba segmentation tool, and so on are used to segment the live broadcast text. Those skilled in the art may flexibly select one to segment the live broadcast text as needed. Further, the preprocessed live broadcast text is converted into a corresponding phoneme sequence. Those skilled in the art may flexibly use corresponding open-source pronunciation dictionary to convert the preprocessed live broadcast text. The phoneme sequence is input into the speech synthesis model. For example, the phoneme sequence is input into the acoustic model of the speech synthesis model, the phoneme sequence is converted into a hidden sequence by the encoder of the acoustic model, information corresponding to each phoneme of the phoneme sequence is predicted by a variance converter of the acoustic model, and the information is added to the hidden sequence. The information corresponding to each phoneme of the phoneme sequence includes a time duration, pitch, and volume of the phoneme. Parallel conversion on the added hidden sequence is performed by a Mel-spectrogram decoder of the acoustic model and a Mel-spectrogram is predicted. The vocoder in the language synthesis model uses the Mel-spectrogram as output and obtains voice and set the voice as the live audio.

Step S1200, the computer determines a first live video that is time-aligned with the live audio and obtains a second live video including the live audio by matching facial movements of a real anchor who is speaking in the first live video with the live audio.

In one embodiment, the computer invokes a prepared source video, and the source video is obtained by recording a high-definition live broadcast of a real anchor in a form of a speech, and a duration of the source video is limited, which may be thirty seconds, one minute, ten minutes, etc. The technology in the field may flexibly prepare the source video according to the present disclosure herein.

It may be understood that the live audio includes a voice segment corresponding to each sentence of the live broadcast text, and each voice segment may be split accordingly. Those skilled in the art may flexibly realize the splitting of the live audio. In one embodiment, for each of the voice segments, in response to a duration of the voice segment being less than or equal to the duration of the source video, a video segment whose duration is equal to the duration of the voice segment is extracted starting from the beginning of the source video. And the video segment is set as a segment of the first live video which is aligned in time sequence. In response to the duration of the voice segment being greater than the duration of the source video, a single source video is spliced cyclically after a single source video until a duration of the spliced source video obtained after splicing at least one source video is greater than the duration of the voice segment. A video segment whose duration is equal to the duration of the voice segment is extracted from the spliced source video. And the video segment is set as the segment of the first live video which is aligned in time sequence of the voice segment. In another embodiment, for each of the voice segments, in response to a duration of the voice segment being less than or equal to the duration of the source video, a video segment equal to half the duration of the voice segment is cut from the beginning of the source video, and after all image frames arranged in time from first to last in the video segment, all the image frames arranged in time from last to first in the video segment are spliced together to obtain a video segment, and the video segment is set as a segment of the first live video which is aligned in time sequence of the voice segment. In response to the duration of the voice segment being greater than the duration of the source video, a single source video is spliced cyclically after a single source video until the video duration of the spliced source video obtained after splicing at least one source video exceeds the duration of the voice segment, and a video segment equal to half the duration of the voice segment is cut from the beginning of the spliced source video, and after all the image frames arranged in time from first to last in the video segment, all the image frames arranged in time from last to first in the video segment are spliced together to obtain a live video segment, and the video segment is set as a segment of the first live video which is aligned in time sequence of the voice segment. Furthermore, after taking the live video segment corresponding to each voice segment except the last voice segment of the live audio, the live video segment of the next voice segment of the voice segment is spliced to obtain the live video corresponding to the live audio.

In one embodiment, the corresponding voice segment corresponding to each moment is split according to an order of a time sequence of the live audio, and a first voice-driven model is used to take the voice segment and the image frame of the first live video corresponding to the moment as input. The first voice-driven model is an open-source model. Voice feature corresponding to the voice segment is extracted through a DeepSpeech recurrent neural network (RNN) of the first voice-driven model, and the voice feature is mapped to a hidden voice mapping expression space through convolutional neural network (CNN), and expression parameters formed by corresponding blendshape linear combination of the hidden voice mapping expression space are determined. The expression parameters are smoothed through a perceptual filter, and a 3D face is reconstructed according to the smoothed expression parameters to obtain a UV map. The UV map is a picture of the speaking facial movements of the real anchor corresponding to the voice segment. The U-Net based on a hollow convolution is used to take the image frame and the UV map as input to render an image frame of an audio-driven real-person that is live. The voice segments corresponding to each moment are spliced in the order of the time sequence, and the image frames corresponding to the voice segments corresponding to each moment are spliced in the order of the time sequence, so as to obtain the second live video containing the live audio. In at least one embodiment, the second live video is an audio-driven real person live broadcast video.

In one embodiment, the first voice-driven model is pre-trained to a convergence state and has learned to predict a first parameter of the facial movement of the 3D face model that is speaking, corresponding to the input voice. An expression parameter calculated from the input image frame containing the portrait with a second parameter of the facial movement that is predicted and re-interpret an ability of the face.

Step S1300, the computer plays the second live video in the live broadcast room, in response to a question input by an audience received in the live broadcast room, the computer pauses the second live video, and plays a first response video that replies to the question. The first response video includes a human voice reply and continuous image frames showing the corresponding facial movements of the real anchor.

In one embodiment, FFmpeg (a video editing tool) is used to encode the image frame of an audio-driven real-person of the second live video and obtain an image set with YUV format. In one embodiment, an image of the image set and the live audio of the second live video are sent to a virtual camera, so that any player pre-packaged with OpenGL may access the virtual camera, decode the image set into an image set with RGB format, and render the image set with the RGB format in the live broadcast room for synchronous playback with the live audio, which realize multiple players share the live broadcast simultaneously in one live broadcasting.

In one embodiment, it may be understood that the audience in the live broadcast room may interact with the anchor in a question-and-answer manner. The audience asks a question to the anchor, and the anchor answers the question. When the audience in the live broadcast room asks a question, a question text is obtained, and a single standard question and a single standard answer that are most semantically similar to the question text in the preset knowledge base of question-and-answer are determined, and a first answer video prepared in advance according to the standard answer is obtained, and encoded into a corresponding image set with YUV format. The player is paused to play the second live video firstly, and then the image set with YUV format is decoded into an image set with RGB format, and the image set with the RGB format is rendered in the live broadcast room and played synchronously with answer voice of human in the first response video. The preparation of the first response video according to the standard answer may be flexibly implemented by those skilled in the art with reference to steps S1100-1200 or some subsequent embodiments.

In one embodiment, the preset knowledge base of question-and-answer includes a plurality of standard questions and standard answers, which are prepared in advance by the copywriter or the real anchor himself based on his estimation of the questions that the audience may ask.

Step S1400, the computer continues to play the second live broadcast video in response that all questions from the audience in the live broadcast room have been answered.

In one embodiment, the computer may continue to play the second live broadcast video in response that all questions from the audience in the live broadcast room have been answered by the first response video.

In one embodiment, the present disclosure generates the live audio corresponding to the live broadcast text, determines the first live video that is aligned with the live audio in time sequence, and obtains a second live video by matching facial movements of a real anchor who is speaking in the first live video with the live audio. The second live video is played in the live broadcasting room. The second live video is paused in response to a question input by an audience received in the live broadcast room, and the first response video that replies to the question is played. The second live video continues to be played in response that all questions from the audience in the live broadcast room have been answered. On the one hand, the present disclosure realized that a video of the live facial movements of the corresponding synchronized live host is generated by a given text, ensuring that the virtual live host in the video is highly similar to the actual live host in terms of appearance, performance and other visual perceptions. By playing such a video for live broadcast, it may avoid making the audience in the live room feel uncomfortable. On the other hand, in the process of broadcasting live by playing the second live video, the first response video may be played to answer the audience's questions in the live room, ensuring that the virtual live host and the audience may interact with each other in questions and answers, increase the audience's sense of participation and presence, and create a good live atmosphere.

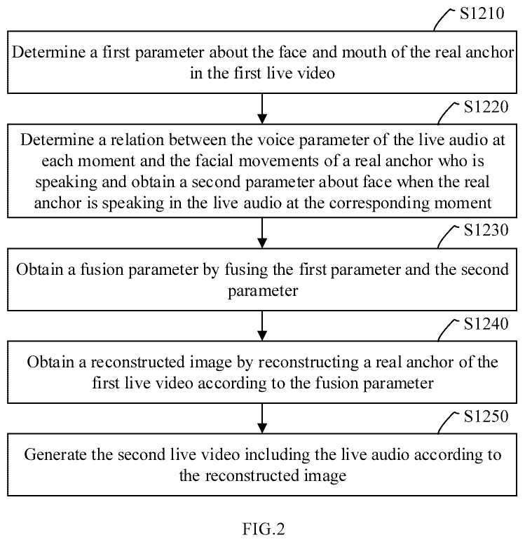

Please refer to FIG. 2, in another embodiment, step S1200, the computer determines a first live video that is time-aligned with the live audio and obtains a second live video by matching facial movements of a real anchor who is speaking in the first live video with the live audio, includes the following steps:

Step S1210, the computer determines a first parameter about the face and mouth of the real anchor in the first live video.

In one embodiment, the first parameter includes a parameter of a mouth of the real anchor and a parameter of a face of the real anchor.

In one embodiment, for an image frame of a real-person corresponding to each moment in the first live video, the CNN model of a second voice-driven model is used to detect a face of the real anchor of the image frame of a real-person who is broadcasting and extract the parameter of the mouth of the real anchor. The CNN model has been pre-trained to convergence and has learned the ability to detect the face in the image frame and extract a key point of the 2D mouth. The 3DDFA model of the second voice-driven model is used to extract the parameter of the face of the real anchor corresponding to the face of the real anchor of the image frame of a real-person who is broadcasting. The parameter of the face of the real anchor includes but is not limited to any one or more of all the key points, a movement, a shape, a posture, and an expression on the face. The 3DDFA has been pre-trained to convergence and has learned the ability to extract the 3D parameters corresponding to the face in the frame image.

In one embodiment, the second voice-driven model is pre-trained until convergence, and learning to generate a reconstructed image corresponding to the speech at each moment, and each reconstructed image is rendered to generate an image of an audio-driven real-person, which includes the audio corresponding to the moment, and all images of the audio-driven real-person corresponding to each moment are concatenated in chronological order to form an audio-driven real-person video.

Step S1220, the computer determines a relation between the voice parameter of the live audio at each moment and the facial movements of a real anchor who is speaking and obtains a second parameter about face when the real anchor is speaking in the live audio at the corresponding moment.

In one embodiment, for speech segment corresponding to each moment in the live audio, a Mel frequency cepstral coefficient (MFCC) algorithm or a perceptual linear prediction (PLP) algorithm of the second audio-driven model is used to extract the speech feature vector of the speech segment, and the speech feature vector is successively convolved through at least two first convolution layers including specific convolution kernels to obtain a convolution transformation vector, and the convolution transformation vector is successively fully connected through at least two fully connected layers to obtain the second parameter, which include an audio-driven expression parameter and an audio-driven mouth parameter.

Step S1230, the computer obtains a fusion parameter by fusing the first parameter and the second parameter.

In one embodiment, the computer obtains a replaced facial parameter of the real anchor by replacing the facial parameter of the real anchor of the first parameter with the audio-driven expression parameter of the second parameter. The computer obtains a replaced mouth parameter of the real anchor by replacing the mouth parameter of the real anchor of the first parameter with the audio-driven mouth parameter of the second parameter. The computer obtains the fusion parameter based on the replaced facial parameter and the replaced mouth parameter.

Step S1240, the computer obtains a reconstructed image by reconstructing a real anchor of the first live video according to the fusion parameter.

In one embodiment, the computer obtains the reconstructed image based on a mouth contour image and a UV map by reconstructing the face of the real anchor of the image frame of a real person who is broadcasting with the fusion parameter. The mouth contour image is used to reflect the mouth contour of a target object in a finally generated synthetic image, and the UV map is used to generate mouth area texture of the face of the real anchor of the image frame of an audio-driven real person.

Step S1250, the computer generates the second live video including the live audio according to the reconstructed image.

In one embodiment, the replaced facial parameter, the replaced mouth parameter and the image frame of a real-person who is broadcasting of the first live video corresponding to each moment are input into an image rendering model of the second audio-driven model, and a texture image of mouth area is obtained by a first rendering network of the image rendering model. In detail, a convolution transformation and a down-sampling transformation are performed on the replaced facial parameter and the replaced mouth parameter to extract deep features of the reconstructed image by sequentially passing the replaced facial parameter and the replaced mouth parameter through a second convolutional layer and a first down-sampling layer of the first rendering network. And an up-sampling transformation is performed on the replaced facial parameter and the replaced mouth parameter by a first up-sampling layer of the first rendering network to restore the resolution of the reconstructed image and obtain the texture image of the mouth area.

In one embodiment, the image frame of the audio-driven real-person of the current moment is obtained by a second rendering network of the image rendering model. A convolution transformation and a down-sampling transformation are performed on the texture image of the mouth area and the image frame of a real-person who is broadcasting to extract deep features of the texture image of the mouth area and the image frame of a real-person who is broadcasting by sequentially passing the texture image of the mouth area and the image frame of a real-person who is broadcasting through a third convolutional layer and a second down-sampling layer of the second rendering network. And an up-sampling transformation is performed on the texture image of the mouth area and the image frame of a real-person who is broadcasting by a second up-sampling layer of the second rendering network to obtain the image frame of an audio-driven real-person. The image frame of an audio-driven real-person also includes the voice segment of the live audio corresponding to the moment.

In one embodiment, image frames corresponding to all moments are spliced into a second live video in chronological order.

In one embodiment, by determining the first parameter and the association between the voice parameter and the facial movements, and the second parameter about the face when the real anchor is speaking from the live audio at the corresponding moment is obtained. A reconstructed image is generated by reconstructing the real anchor in the first live video according to the fusion parameter. The first audio-driven live video containing the live speech is generated based on the reconstructed image. It may ensure that the speaking face of the real anchor in the first audio-driven live video is highly close to the real speaking face of the real anchor when speaking the corresponding live speech, avoiding sense of disharmony that is inconsistent with the actual perception.

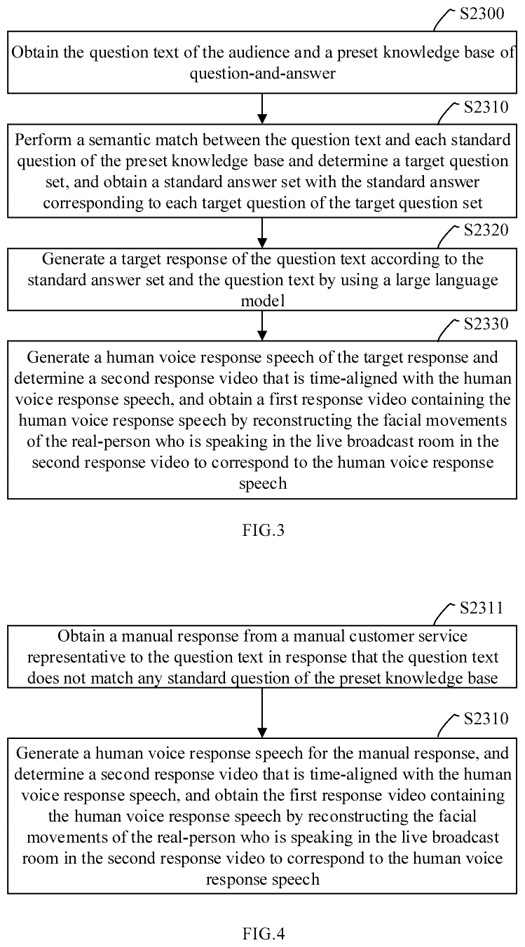

Please refer to FIG. 3, in another embodiment, before step S1300, playing a first response video that replies to the question includes the following steps:

Step S2300, the computer obtains the question text of the audience and a preset knowledge base of question-and-answer, where the preset knowledge base includes a plurality of standard questions and a plurality of standard answers corresponding to the plurality of standard questions.

In one embodiment, the copywriter or the real anchor may estimate in advance the questions that the audience may ask and formulate a plurality of standard questions and their standard answers accordingly to form the preset knowledge base of question-and-answer and the base to the server for use.

In one embodiment, the computer triggers an event of responding to the question of the audience in response that the audience in the live broadcast room asking the question. The computer obtains the text of the question asked by the audience in the live broadcast room and invokes the preset knowledge base of the question-and-answer.

Step S2310: the computer performs a semantic match between the question text and each standard question of the preset knowledge base and determines a target question set, and obtains a standard answer set with the standard answer corresponding to each target question of the target question set.

In at least one embodiment, an open-source text encoding model is used to take the question text and each standard question of the question-answering knowledge base as input, extract a deep semantic feature of each input text, and obtain a text feature vector corresponding to each deep semantic feature. The text encoding model is pre-trained to convergence and learns the ability to encode the text feature vector corresponding to the input text. The text encoding model may be selected from a Text Transfomer, a ROBERTa, a XLM-ROBERTa, a MPNet, a BERT, etc. And technicians in this field may choose one to implement as needed.

In at least one embodiment, a vector distance algorithm is used to calculate a vector distance between the text feature vector of the question text and the text feature vector of each standard question, and multiple standard questions whose vector distance exceeds a preset threshold are determined as target questions to form the target question set. The preset threshold may be set by those skilled in the art as needed.

In at least one embodiment, the standard answer corresponding to each target question of the target question set of the preset knowledge base is obtained to form the standard answer set.

Step S2320: the computer generates a target response of the question text according to the standard answer set and the question text by using a large language model.

In at least one embodiment, the large language model is suitable for text processing in the field of NLP. It is pre-trained with an extremely large corpus until convergence, acquires the ability to generate human language, and has a certain degree of accurate text semantic understanding and logical reasoning ability. The large language model includes an OPT, a Chinchilla, a PaLM, a LLaMA, an Alpaca, a Vicuna, a GPT3, a GPT3.5, a GPT4, etc.

In at least one embodiment, the computer invokes a preset prompt template, which includes a task description, a given question text to be embedded, and a given answer basis to be embedded. Those skilled in the art may refer to the following disclosure to flexibly set the prompt template. The exemplary prompt template is as follows:

The task description in the template is: “Generate a response text to the given question text based on the following given response basis. Do not mix fabricated elements in the response text.”

The given question text to be embedded in the template: “given question text: ${query}$”. The given answer basis to be embedded in the template: “given answer basis: ${context}$”.

In one embodiment, the computer obtains the prompt text by embedding the question text into the given question text to be embedded in the prompt template, and embedding the standard answer set into the given answer basis to be embedded in the prompt template. The server obtains the answer text by inputting the prompt text into the large language model and set the answer text as the target answer.

Step S2330, the computer generates a human voice response speech of the target response and determines a second response video that is time-aligned with the human voice response speech, and obtains a first response video containing the human voice response speech by reconstructing the facial movements of the real-person who is speaking in the live broadcast room in the second response video to correspond to the human voice response speech.

Those skilled in the art may refer to steps S1100-1200 or the preceding embodiments for flexible implementation, and this step will not be described in detail.

In this embodiment, the disclosure presents the first response video corresponding to the constructed answer text to address the questions posed by the audience. By utilizing the large language model to distill the corresponding key content from multiple standard replies highly related to the question text, followed by carefully crafting and organizing the logical expression of the answer text, which ensures the completeness and reliability of the answer, thereby accurately answering the question of the audience.

Please refer to FIG. 4. in another embodiment, after performing semantic matching between the question text and each standard question of the preset knowledge base in step S2310, the following steps are included:

Step S2311, the computer obtains a manual response from a manual customer service representative to the question text in response that the question text does not match any standard question of the preset knowledge base.

In one embodiment, an open-source text encoding model is used to take the question text and each standard question in the preset knowledge base as input, extract the deep semantic features of each input text, and obtain a text feature vector corresponding to each deep semantic feature. The text encoding model is pre-trained to convergence and learns the ability to encode the text feature vector corresponding to the input text. The text encoding model may be selected from a Text Transfomer, a ROBERTa, a XLM-ROBERTa, a MPNet, a BERT, etc., and technicians in this field may choose one to implement as needed.

In one embodiment, a vector distance algorithm is used to calculate the vector distance between a text feature vector of the question text and a text feature vector of each standard question. The computer determines that the question text does not match any standard question of the preset knowledge base in response that each vector distance is not greater than a preset threshold. At this time, the server first pushes the question text to the manual customer service so that the manual customer service may reply to the question text, and then receives the corresponding answer text returned by the manual customer service and uses the answer text as the manual response.

Step S2312, the computer generates a human voice response speech for the manual response, and determines a second response video that is time-aligned with the human voice response speech, and obtains the first response video containing the human voice response speech by reconstructing the facial movements of the real-person who is speaking in the live broadcast room in the second response video to correspond to the human voice response speech.

Those skilled in the art may refer to steps S1100-1200 or the preceding embodiments for flexible implementation, and this step will not be described in detail.

In this embodiment, when the question text does not match any standard question of the preset knowledge base, a manual response from an artificial customer service representative to the question text is obtained, and a first response video corresponding to the manual response is constructed, thereby ensuring the robustness of the question-and-answer interaction with the audience, thereby ensuring that every question has an answer.

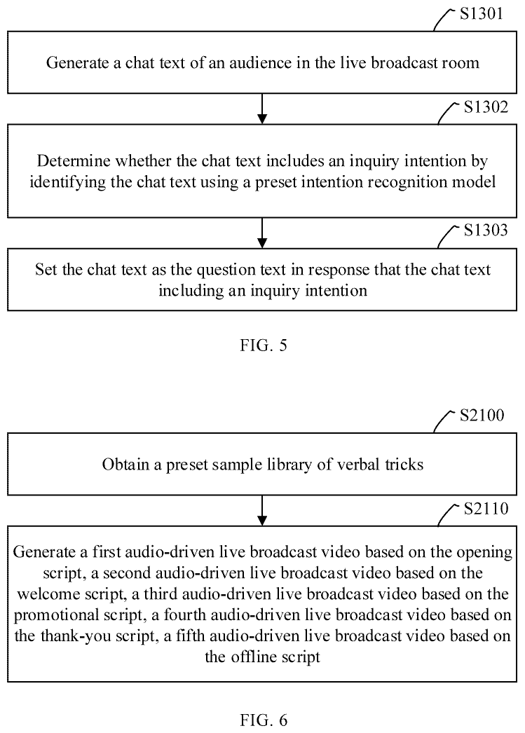

Please refer to FIG. 5, in another embodiment, step S1300, after playing the second live video in the live broadcast room, includes the following steps:

Step S1301, the computer generates a chat text of an audience in the live broadcast room.

It may be understood that the audience in the live broadcast room may interact with the anchor in a chat manner and the chat text is generated. Accordingly, whenever the audience in the live broadcast room interacts with the anchor, the server generates the chat text.

Step S1302: the computer determines whether the chat text includes an inquiry intention by identifying the chat text using a preset intention recognition model.

In one embodiment, the intention recognition model has been pre-trained to a convergent state and has acquired the ability to recognize whether the chat text includes an inquiry intention. As a training process of the intention recognition model is known in the art, technicians in this field may flexibly and adaptably implement corresponding training of the intention recognition model based on the forward reasoning process of the intention recognition model disclosed subsequently, so that the intention recognition model after training to convergence has the above ability. In one embodiment, the intention recognition model is implemented by using a Bert, and the chat text is segmented using a word segmentation algorithm to obtain a word segmentation sequence, a [CLS] identifier is added at a starting position of the word segmentation sequence and a [SEP] identifier is added at an ending position, and then the word segmentation sequence is input into the intention recognition model, and an input embedding vector of each identifier and word unit in the word segmentation sequence is determined through a WordPiece embedding layer in the intention recognition model, and the input embedding vector is input into a multi-layer stacked Transformer encoder to obtain a text feature vector of each identifier and word unit in the word segmentation sequence output by the last layer of Transformer encoder, and a linear transformation operation is performed on the text feature vector of the [CLS] identifier through a feedforward neural network layer, and then a binary probability distribution is obtained through a Softmax layer, and the binary probability distribution includes a probability of a first category and a probability of a second category, the first category represents that the input text includes an inquiry intent, and the second category represents that the input text does not include an inquiry intent. The category corresponding to a maximum probability in the binary probability distribution is determined. The computer determines that the chat text includes an inquiry intention in response that the category is the first category. The computer determines that the chat text does not include an inquiry intention in response that the category is the second category.

Step S1303, the computer sets the chat text as the question text in response that the chat text including an inquiry intention.

In one embodiment, the computer determines that the chat text including the inquiry intention in response that the category with the maximum probability of the binary probability distribution is the first category, and sets the chat text as a question text.

In this embodiment, the intention recognition model is used to identify whether a chat text contains an inquiry intention, and thus the chat text containing the inquiry intention is confirmed as a question text, which may ensure the accuracy of the recognition and high recognition efficiency.

Please refer to FIG. 6, in another embodiment, before step S1100, obtaining a live broadcast text, the following steps are included:

Step S2100: the computer obtains a preset sample library of verbal tricks.

In one embodiment, the sample library is pre-edited by the copywriter or the real anchor, including at least one opening script, at least one welcome script, at least one promotional script, at least one thank-you script, and at least one offline script. For ease of understanding, the opening script is as follows: “Hello everyone, welcome to the live broadcast room! I am very happy to have a good time with you all today”, welcome script: “Welcome new friends to join us, and hope that everyone may find their own fun and gains here.” Promotional script: “Here, we have a lot of wonderful content waiting for everyone, remember to follow us, don't miss more wonderful content!”, Thank-you script: “Thank you very much for the participation and support of my family. Without you, there would be no live broadcast today. I hope we may continue to meet in future live broadcasts!”, Offline script: “Time flies, today's live broadcast is about to end, I hope everyone likes today's content, and see you next time!”

Step S2110, the computer generates a first audio-driven live broadcast video based on the opening script, a second audio-driven live broadcast video based on the welcome script, a third audio-driven live broadcast video based on the promotional script, a fourth audio-driven live broadcast video based on the thank-you script, a fifth audio-driven live broadcast video based on the offline script.

In one embodiment, for each opening speech of the sample library, a human voice speech of the opening speech is generated, a real person video that is aligned with the human voice speech in time sequence is determined, and the facial movements of the real-person who is speaking in the live broadcast room in the real person video are reconstructed to correspond to the human voice speech, and the first audio-driven live broadcast video containing the human voice speech is obtained. Those skilled in the art may refer to steps S1100-1200 or the previous embodiments to flexibly implement this step, and this step will not be repeated.

In one embodiment, for each welcome speech of the sample library, a human voice speech of the welcome speech is generated, a real-person video that is aligned with the human voice speech in time sequence is determined, and the facial movements of the real-person who is speaking in the live broadcast room in the second response video are reconstructed to correspond to the human voice speech, and the second audio-driven live broadcast video containing the human voice speech is obtained. Those skilled in the art may refer to steps S1100-1200 or the previous embodiments to flexibly implement this step, and this step will not be repeated.

In one embodiment, for each promotional script of the sample library, a human voice speech of the promotional script is generated, a real person video that is aligned with the human voice speech in time sequence is determined, and the facial movements of the real-person who is speaking in the live broadcast room in the second response video are reconstructed to correspond to the human voice speech, and the third audio-driven live broadcast video containing the human voice speech is obtained. Those skilled in the art may refer to steps S1100-1200 or the previous embodiments to flexibly implement this step, and this step will not be repeated.

In one embodiment, for each thank-you speech in the sample library, a human voice speech of the thank-you script is generated, a real person video that is aligned with the human voice speech in time sequence is determined, and the facial movements of the real-person who is speaking in the live broadcast room in the second response video are reconstructed to correspond to the human voice speech, and the fourth audio-driven live broadcast video containing the human voice speech is obtained. Those skilled in the art may refer to steps S1100-1200 or the previous embodiments to flexibly implement this step, and this step will not be repeated.

In one embodiment, for each offline speech in the sample library, a human voice speech of the offline speech is generated in response that the audio-driven real person is leaving the live broadcast room, a real person video that is aligned with the human voice speech in time sequence is determined, and the facial movements of the real-person who is speaking in the live broadcast room in the second response video are reconstructed to correspond to the human voice speech, and the fifth audio-driven live broadcast video containing the human voice speech is obtained. Those skilled in the art may refer to steps S1100-1200 or the previous embodiments to flexibly implement this step, and this step will not be repeated.

In this embodiment, the opening speech, welcome speech, promotional speech, thank-you speech and off-line speech in the sample library are disclosed, and the corresponding first audio-driven live broadcast video, the second audio-driven live broadcast video, the third audio-driven live broadcast video, the fourth audio-driven live broadcast video and the fifth audio-driven live broadcast video are disclosed.

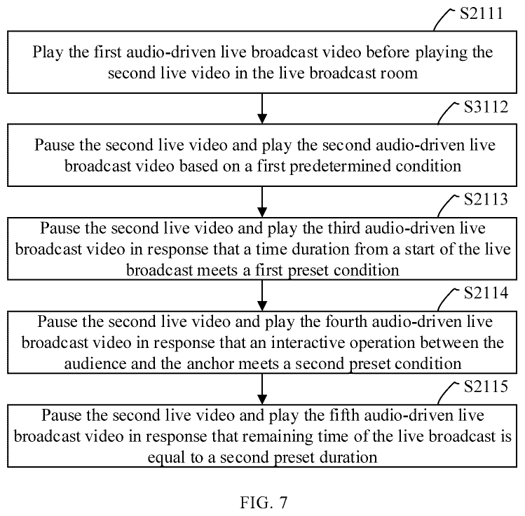

Please refer to FIG. 7, in another embodiment, after step S2110, the computer generates a first audio-driven live broadcast video based on the opening script, a second audio-driven live broadcast video based on the welcome script, a third audio-driven live broadcast video based on the promotional script, a fourth audio-driven live broadcast video based on the thank-you script, a fifth audio-driven live broadcast video based on the offline script, the following steps are included:

Step S2111, the computer plays the first audio-driven live broadcast video before playing the second live video in the live broadcast room.

In at least one embodiment, when the live broadcast begins or kicks off, it is necessary to mobilize emotions of the audience in the live broadcast room and make the audience aware that the live broadcast has officially started. Therefore, FFmpeg is used to encode the first audio-driven live broadcast video into a corresponding YUV format image data set. The player first decodes the YUV format image data set into an RGB format image data set and renders the RGB format image data set in the live broadcast room and plays the RGB format image data set synchronously with the human voice in the audio-driven live broadcast video.

Step S2112, the computer pauses the second live video and plays the second audio-driven live broadcast video based on a first predetermined condition, the first predetermined condition includes a duration of a new audience joining the live broadcast room is greater than a first preset threshold during the second live video is playing in the live broadcast room, and the number of new audiences joining the live broadcast room within a first preset duration is greater than a second preset threshold during the second live video is playing in the live broadcast room.

In one embodiment, the computer monitors the live broadcast room, the computer determines a time difference between a timestamp of a current new audience joining the live broadcast room and a timestamp of a last new audience joining the live broadcast room and sets the time difference as the duration. When the duration is greater than the first preset threshold, it means that a relatively long time has passed before a new audience joins the live broadcast room. On the other hand, it may also determine the number of new audiences who have joined the live broadcast room from the time the current new audience joins the live broadcast room until a certain time has passed. When the number of new audiences is greater than the second preset threshold, it means that a relatively short period of time has passed with a large number of new audiences joining the live broadcast room. According to the above two aspects, when the duration for new audiences to join the live broadcast room is greater than the first preset threshold, or the number of new audiences who have joined the live broadcast room within the first preset duration is greater than the second preset threshold, it is necessary to welcome the new audience to ensure preserving the sense of belonging and existence for new audiences. Therefore, FFmpeg is used to encode the first audio-driven live broadcast video into a corresponding YUV format image data set, and the player pauses the second live video, and then the YUV format image data set is decoded into an RGB format image data set, and the RGB format image data set is rendered in the live broadcast room and played synchronously with the human voice in the first audio-driven live broadcast video. The first preset threshold and the first preset duration may be set as needed by those skilled in the art.

Step S2113, the computer pauses the second live video and plays the third audio-driven live broadcast video in response that a time duration from a start of the live broadcast meets a first preset condition.

In one embodiment, the server monitors the live broadcast room, the server determines a time difference between a current timestamp and a timestamp of the start of the live broadcast, that is, the time duration from the start of the live broadcast. In response that the time duration is equal to N*M, it is determined that meets the preset conditions. FFmpeg is used to encode the third audio-driven live broadcast video into a corresponding YUV format image data set, and the player pauses the second live broadcast video, and then the YUV format image data set is decoded into an RGB format image data set, and the RGB format image data set is rendered in the live broadcast room and played synchronously with the human voice speech in the third audio-driven live broadcast video. The N is a number set containing multiple numbers, and the Mis a fixed time duration. The number of the specific number set and the value of each number, and the fixed time duration may be set as needed by those skilled in the art. For ease of understanding, for example, the N is {1, 2, 4, 7, 10}, and Mis 5 minutes. N*M is {5, 10, 20, 35, 50}, the time duration is equal to 5, or equal to 10, or equal to 15, or equal to 20, or equal to 25, the first preset condition is met.

Step S2114, the computer pauses the second live video and plays the fourth audio-driven live broadcast video in response that an interactive operation between the audience and the anchor meets a second preset condition.

In one embodiment, the interactive operation between the audience and the anchor meets the preset second condition, the preset second condition may be any of the following:
a first performance of the audience, such as liking the anchor, following the anchor, sharing the anchor, and the number of the first performance of the audience exceeds a third preset threshold.
a second performance of the audience, such as the number of purchased products displayed by the anchor in the live broadcast exceeds a fourth preset threshold.
a third performance of the audience, such as rewarding the anchor with a virtual gift.
a fourth performance of the audience, such as praising the anchor, praising the anchor for the products displayed during the live broadcast, and praising the live broadcast effect, and a total number of chat texts of the audience exceeds a fifth preset threshold.

The third preset threshold, the fourth preset threshold, and the fifth preset threshold may be set by those skilled in the art as needed.

In one embodiment, in response that the interactive operation between the audience and the anchor meets the preset condition, FFmpeg is used to encode the fourth audio-driven live broadcast video into a corresponding YUV format image data set. The player pauses to play the second live video, and then the YUV format image data set is decoded into an RGB format image data set. The RGB format image data set is rendered in the live broadcast room and played synchronously with the human voice of the thank-you speech in the fourth audio-driven live broadcast video.

Step S2115, the computer pauses the second live video and plays the fifth audio-driven live broadcast video in response that remaining time of the live broadcast is equal to a second preset duration.

In one embodiment, the second preset duration is equal to a total duration of the live broadcast minus a duration of the live broadcast video driven by the audio driver. The total duration of the live broadcast is the duration from the start to the end of the live broadcast, which is generally planned and determined in advance by the anchor himself.

The computer determines the time difference between a current timestamp and a timestamp of the start of the live broadcast by monitoring the live broadcast room, which is the time duration from the start of the live broadcast. When the time duration is equal to the second preset duration, FFmpeg is used to encode the audio-driven live broadcast video into a corresponding YUV format image data set, and the player pauses the second live broadcast video, and then the YUV format image data set is decoded into an RGB format image data set, and the RGB format image data set is rendered in the live broadcast room and played synchronously with the human voice in the fifth audio-driven live broadcast video.

In one embodiment, it is revealed that the first audio-driven live broadcast video, the second audio-driven live broadcast video, the third audio-driven live broadcast video, the fourth audio-driven live broadcast video, and the fifth audio-driven live broadcast video are played at their respective playback times. On the one hand, it may achieve the playback of the corresponding video at the appropriate playback time without the need for human supervision and full automation. On the other hand, by playing the videos corresponding to various scripts, it may be highly close to the effect of actual live broadcast, which may increase the interaction between the anchor and the audience, make the audience more involved, and create a good live broadcast atmosphere.

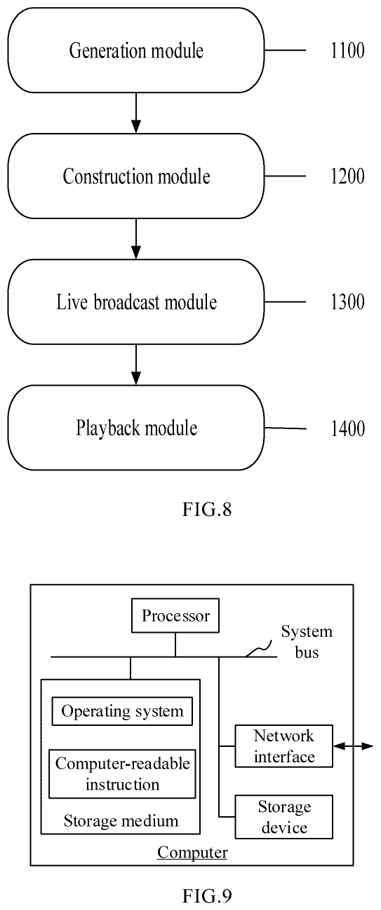

Please refer to FIG. 8, a digital human live broadcast apparatus provided to meet one of the purposes of the present disclosure is a functional embodiment of the live broadcast method of the present disclosure. On the other hand, the apparatus is a digital human live broadcast apparatus provided to meet one of the purposes of the present disclosure, including a generation module 1100, a construction module 1200, a live broadcast module 1300, and a playback module 1400. The generation module 1100 is used to obtain a live broadcast text and generate a live audio based on the live broadcast text. The construction module 1200 is used to determine a first live video that is time-aligned with the live audio and obtain a second live video comprising the live audio by matching facial movements of a real anchor who is speaking in the first live video with the live audio. The live broadcast module 1300 is used to pause the second live video in response to a question input by an audience received in the live broadcast room, and play a first response video that replies to the question, the first response video comprising a human voice reply and continuous image frames showing the corresponding facial movements of the real anchor. The playback module 1400 is used to continue playing the second live broadcast video in response that all questions from the audience in the live broadcast room have been answered.

In another embodiment, the construction module 1200 includes: a first determination submodule, used to a first parameter about the face and mouth of the real anchor in the first live video; a second determination submodule, used to determine a relation between a voice parameter of the live audio at each moment and facial movements of the real anchor who is speaking and obtaining a second parameter about face when the real anchor is speaking from the live audio at the corresponding moment; a parameter fusion submodule, used to obtain a fusion parameter by fusing the first parameter and the second parameter; an image reconstruction submodule, used to obtain a reconstructed image by reconstructing the real anchor of the first live video according to the fusion parameter; a video generation submodule, used to generate the second live video according to the reconstructed image.

In another embodiment, the live broadcast module 1300 includes: a data acquisition submodule for obtaining a question text of the audience and a preset knowledge base of question-and-answer, where the preset knowledge base includes a plurality of standard questions and a plurality of standard answers corresponding to the plurality of standard questions; performing a semantic match between the question text and each standard question of the preset knowledge base and determining a target question set. An answer set construction submodule is used to obtain a standard answer set with the standard answer corresponding to each target question of the target question set. An answer generation submodule is used to generate a target response of the question text according to the standard answer set and the question text by using a large language model. A first answer video generation submodule is used to generate a human voice response speech of the target response and determining a second response video that is time-aligned with the human voice response speech, and obtain a first response video comprising the human voice response speech by reconstructing the facial movements of the real-person who is speaking in the live broadcast room in the second response video to correspond to the human voice response speech.

In another embodiment, after the answer set construction submodule, it includes: a manual response submodule, which is used to obtain a manual response from a manual customer service representative to the question text in response that the question text does not match any standard question of the preset knowledge base; a second answer video generation submodule, which is used to generate a human voice response speech for the manual response, and a second response video that is time-aligned with the human voice response speech, and obtain the first response video containing the human voice response speech by reconstructing the facial movements of the real-person who is speaking in the live broadcast room video in the second response video to correspond to the human voice response speech.

In another embodiment, the live broadcast module 1300 includes: a text acquisition submodule for acquiring a chat text of an audience in the live broadcast room; an intention recognition submodule for determining whether the chat text comprising an inquiry intention by using a preset intention recognition model to identify the chat text; and a text determination submodule for setting the chat text as the question text in response that the chat text comprising the inquiry intention.

In another embodiment, before the voice generation module 1100, it includes: a speech library acquisition submodule, which is used to obtain a preset sample library of verbal tricks; a speech video construction submodule, which is used to generate a first audio-driven live broadcast video based on an opening script of the preset sample library, a second audio-driven live broadcast video based on a welcome script of the preset sample library, a third audio-driven live broadcast video based on a promotional script of the preset sample library, a fourth audio-driven live broadcast video based on a thank-you script of the preset sample library, and a fifth audio-driven live broadcast video based on an offline script of the preset sample library.

In another embodiment, after the speech video construction submodule, it includes: a video playback submodule, which is used to play the first audio-driven live broadcast video before playing the second live video in the live broadcast room; a welcome drive submodule, which is used to pause the second live video and playing the second audio-driven live broadcast video based on a first predetermined condition, the first predetermined condition including a duration of a new audience joining the live broadcast room is greater than a first preset threshold during the second live video is playing in the live broadcast room, and the number of new audiences joining the live broadcast room within a first preset duration is greater than a second preset threshold during the second live video is playing in the live broadcast room; a publicity drive submodule, which is used to pause the second live video and playing the third audio-driven live broadcast video in response that a time duration from a start of the live broadcast meets a first preset condition; a thank-you drive submodule, which is used to pause the second live video and playing the fourth audio-driven live broadcast video in response that an interactive operation between the audience and the anchor meets a second preset condition; and a downcast drive submodule, which is used to pause the second live video and playing the fifth audio-driven live broadcast video in response that remaining time of the live broadcast is equal to a second preset duration.

To solve the above technical problems, the embodiment of the present disclosure also provides a computer. As shown in FIG. 9, a schematic diagram of the internal structure of a computer. The computer includes a processor, a computer-readable storage medium, a storage device, and a network interface connected by a system bus. Among them, the computer-readable storage medium of the computer stores an operating system, a database, and a computer-readable instruction, and the database may store a control information sequence. When the computer-readable instruction is executed by the processor, the processor may implement a live broadcast method. The processor of the computer is used to provide computing and control capabilities to support the operation of the entire computer. The storage medium of the computer may store computer-readable instructions, and when the computer-readable instruction is executed by the processor, the processor may execute the live broadcast method of the present disclosure. The network interface of the computer is used to connect and communicate with the terminal. It may be understood by those skilled in the art that the structure shown in FIG. 10 is only a block diagram of a partial structure related to the scheme of the present disclosure and does not constitute a limitation on the computer to which the scheme of the present disclosure is applied. The specific computer may include more or fewer components than shown in the figure, or combine certain components, or have different component arrangements.

In this embodiment, the processor is used to execute the specific functions of each module and its submodule in FIG. 8, and the storage device stores the program code and various data required to execute the above modules or submodules. The network interface is used to transmit data between user terminals or servers. The memory in this embodiment stores the program code and data required to execute all modules/submodules in the live broadcast device of the present disclosure, and the server may invoke the program code and data of the server to execute the functions of all submodules.

The present disclosure also provides a storage medium storing computer-readable instruction. When the computer-readable instructions are executed by one or more processors, the one or more processors execute the steps of the live broadcast method of any embodiment of the present disclosure.

A person skilled in the art may understand that the implementation of all or part of the processes in the above-mentioned embodiments of the present disclosure may be completed by instructing the relevant hardware through a computer program, and the computer program may be stored in a computer-readable storage medium. When the program is executed, it may include the processes of the embodiments of the above-mentioned methods. Among them, the aforementioned storage medium may be a computer-readable storage medium such as a disk, an optical disk, a read-only memory (ROM), or a random access memory (RAM).

In summary, the present disclosure constructs a real anchor that simulates reality to perform live broadcasts and may interact with the audience by conducting question-and-answer sessions during the live broadcast.

It will be understood by those skilled in the art that the various operations, methods, steps, measures, and schemes in the processes discussed in this disclosure may be alternated, changed, combined, or deleted. Furthermore, other steps, measures, and schemes in the various operations, methods, and processes discussed in this disclosure may also be alternated, changed, rearranged, decomposed, combined, or deleted. Furthermore, the steps, measures, and schemes in the various operations, methods, and processes in the prior art that are open source and in the present disclosure may also be alternated, changed, rearranged, decomposed, combined, or deleted.

The above description is only a partial implementation method of the present disclosure. It should be pointed out that for ordinary technicians in this technical field, several improvements and modifications may be made without departing from the principles of the present disclosure. These improvements and modifications should also be regarded as the scope of protection of the present disclosure.

What is claimed is:

1. A live broadcast method, comprising:
obtaining a live broadcast text and generating a live audio based on the live broadcast text;
determining a first live video that is time-aligned with the live audio and obtaining a second live video comprising the live audio by matching facial movements of a real anchor who is speaking in the first live video with the live audio; and
playing the second live video in a live broadcast room;
in response to a question input by an audience received in the live broadcast room, pausing the second live video, and playing a first response video that replies to the question, the first response video comprising a human voice reply and continuous image frames showing the corresponding facial movements of the real anchor;
continuing to play the second live broadcast video in response that all questions from the audience in the live broadcast room have been answered.

2. The live broadcast method according to claim 1, wherein the obtaining the second live video comprising the live audio by matching facial movements of the real anchor who is speaking in the first live video with the live audio comprises:
determining a first parameter about the face and mouth of the real anchor in the first live video;
determining a relation between a voice parameter of the live audio at each moment and facial movements of the real anchor who is speaking, and obtaining a second parameter about face when the real anchor is speaking in the live audio at the corresponding moment;
obtaining a fusion parameter by fusing the first parameter and the second parameter;
obtaining a reconstructed image by reconstructing the real anchor of the first live video according to the fusion parameter; and
generating the second live video according to the reconstructed image.

3. The live broadcast method according to claim 1, wherein before playing the first response video that replies to the question, the method further comprises:
obtaining a question text of the audience and a preset knowledge base of question-and-answer, wherein the preset knowledge base comprises a plurality of standard questions and a plurality of standard answers corresponding to the plurality of standard questions;
performing a semantic match between the question text and each standard question of the preset knowledge base and determining a target question set;
obtaining a standard answer set with the standard answer corresponding to each target question of the target question set; and
generating a target response of the question text according to the standard answer set and the question text by using a large language model;
generating a human voice response speech of the target response and determining a second response video that is time-aligned with the human voice response speech, and obtaining a first response video comprising the human voice response speech by reconstructing facial movements of the real-person who is speaking in the live broadcast room in the second response video to correspond to the human voice response speech.

4. The live broadcast method according to claim 3, wherein after performing the semantic match between the question text and each standard question of the preset knowledge base, the method further comprises:
obtaining a manual response from a manual customer service representative to the question text in response that the question text does not match any standard question of the preset knowledge base;
generating a human voice response speech for the manual response;
determining a second response video that is time-aligned with the human voice response speech, and obtaining the first response video comprising the human voice response speech by reconstructing the facial movements of the real-person who is speaking in the live broadcast room in the second response video to correspond to the human voice response speech.

5. The live broadcast method according to claim 1, wherein after playing the second live video in the live broadcast room, the method further comprises:
generating a chat text of an audience in the live broadcast room;
determining whether the chat text comprises an inquiry intention by identifying the chat text using a preset intention recognition model;
setting the chat text as the question text in response that the chat text comprises the inquiry intention.

6. The live broadcast method according to claim 1, wherein before obtaining the live broadcast text, the method further comprises:
obtaining a preset sample library of verbal tricks;
generating a first audio-driven live broadcast video based on an opening script of the preset sample library, a second audio-driven live broadcast video based on a welcome script of the preset sample library, a third audio-driven live broadcast video based on a promotional script of the preset sample library, a fourth audio-driven live broadcast video based on a thank-you script of the preset sample library, and a fifth audio-driven live broadcast video based on an offline script of the preset sample library.

7. The live broadcast method according to claim 6, further comprising:
playing the first audio-driven live broadcast video before playing the second live video in the live broadcast room;
pausing the second live video and playing the second audio-driven live broadcast video based on a first predetermined condition, the first predetermined condition comprising a duration of a new audience joining the live broadcast room is greater than a first preset threshold during the second live video is playing in the live broadcast room, and the number of new audiences joining the live broadcast room within a first preset duration is greater than a second preset threshold during the second live video is playing in the live broadcast room;
pausing the second live video and playing the third audio-driven live broadcast video in response that a time duration from a start of the live broadcast meets a first preset condition;
pausing the second live video and playing the fourth audio-driven live broadcast video in response that an interactive operation between the audience and the anchor meets a second preset condition;
pausing the second live video and playing the fifth audio-driven live broadcast video in response that remaining time of the live broadcast is equal to a second preset duration.

8. A computer comprising:
a storage device;
at least one processor; and
the storage device storing one or more programs that, when executed by the at least one processor, cause the at least one processor to:
obtain a live broadcast text and generate a live audio based on the live broadcast text;
determine a first live video that is time-aligned with the live audio and obtain a second live video comprising the live audio by matching facial movements of a real anchor who is speaking in the first live video with the live audio; and
play the second live video in a live broadcast room;
in response to a question input by an audience received in the live broadcast room, pause the second live video, and play a first response video that replies to the question, the first response video comprising a human voice reply and continuous image frames showing the corresponding facial movements of the real anchor;
continue to play the second live broadcast video in response that all questions from the audience in the live broadcast room have been answered.

9. The computer according to claim 8, wherein the at least one processor obtains the second live video comprising the live audio by matching facial movements of a real anchor who is speaking in the first live video with the live audio by:
determining a first parameter about the face and mouth of the real anchor in the first live video;
determining a relation between a voice parameter of the live audio at each moment and facial movements of the real anchor who is speaking, and obtaining a second parameter about face when the real anchor is speaking in the live audio at the corresponding moment;
obtaining a fusion parameter by fusing the first parameter and the second parameter;
obtaining a reconstructed image by reconstructing the real anchor of the first live video according to the fusion parameter; and
generating the second live video according to the reconstructed image.

10. The computer according to claim 8, wherein before the at least one processor plays the first response video that replies to the question, the at least one processor is further caused to:
obtain a question text of the audience and a preset knowledge base of question-and-answer, wherein the preset knowledge base comprises a plurality of standard questions and a plurality of standard answers corresponding to the plurality of standard questions;
perform a semantic match between the question text and each standard question of the preset knowledge base and determining a target question set;
obtain a standard answer set with the standard answer corresponding to each target question of the target question set; and
generate a target response of the question text according to the standard answer set and the question text by using a large language model;
generate a human voice response speech of the target response and determining a second response video that is time-aligned with the human voice response speech, and obtain a first response video comprising the human voice response speech by reconstructing facial movements of the real-person who is speaking in the live broadcast room in the second response video to correspond to the human voice response speech.

11. The computer according to claim 10, wherein after the at least one processor performs the semantic match between the question text and each standard question of the preset knowledge base, the at least one processor is further caused to:
obtain a manual response from a manual customer service representative to the question text in response that the question text does not match any standard question of the preset knowledge base;
generate a human voice response speech for the manual response;
determine a second response video that is time-aligned with the human voice response speech, and obtain the first response video containing the human voice response speech by reconstructing the facial movements of the real-person who is speaking in the live broadcast room in the second response video to correspond to the human voice response speech.

12. The computer according to claim 8, wherein after the at least one processor plays the second live video in the live broadcast room, the at least one processor is further caused to:
generate a chat text of an audience in the live broadcast room;
determine whether the chat text comprises an inquiry intention by identifying the chat text using a preset intention recognition model;
set the chat text as the question text in response that the chat text comprises the inquiry intention.

13. The computer according to claim 8, wherein before the at least one processor obtains the live broadcast text, the at least one processor is further caused to:
obtain a preset sample library of verbal tricks;
generate a first audio-driven live broadcast video based on an opening script of the preset sample library, a second audio-driven live broadcast video based on a welcome script of the preset sample library, a third audio-driven live broadcast video based on a promotional script of the preset sample library, a fourth audio-driven live broadcast video based on a thank-you script of the preset sample library, a fifth audio-driven live broadcast video based on an offline script of the preset sample library.

14. The computer according to claim 13, wherein the at least one processor is further caused to:
play the first audio-driven live broadcast video before playing the second live video in the live broadcast room;
pause the second live video and play the second audio-driven live broadcast video based on a first predetermined condition, the first predetermined condition comprises a duration of a new audience joining the live broadcast room is greater than a first preset threshold during the second live video is playing in the live broadcast room, and the number of new audiences joining the live broadcast room within a first preset duration is greater than a second preset threshold during the second live video is playing in the live broadcast room;
pause the second live video and play the third audio-driven live broadcast video in response that a time duration from a start of the live broadcast meets a first preset condition;
pause the second live video and play the fourth audio-driven live broadcast video in response that an interactive operation between the audience and the anchor meets a second preset condition;
pause the second live video and play the fifth audio-driven live broadcast video in response that remaining time of the live broadcast is equal to a second preset duration.

15. A non-transitory storage medium having instructions stored thereon, when the instructions are executed by a processor of a computer, the processor is caused to perform a live broadcast method, wherein the method comprises:
obtaining a live broadcast text and generating a live audio based on the live broadcast text;
determining a first live video that is time-aligned with the live audio and obtaining a second live video comprising the live audio by matching facial movements of a real anchor who is speaking in the first live video with the live audio; and
playing the second live video in a live broadcast room;
in response to a question input by an audience received in the live broadcast room, pausing the second live video, and playing a first response video that replies to the question, the first response video comprising a human voice reply and continuous image frames showing the corresponding facial movements of the real anchor;
continuing to play the second live broadcast video in response that all questions from the audience in the live broadcast room have been answered.

16. The non-transitory storage medium according to claim 15, wherein the obtaining the second live video comprising the live audio by matching facial movements of the real anchor who is speaking in the first live video with the live audio comprises:
determining a first parameter about the face and mouth of the real anchor in the first live video;
determining a relation between a voice parameter of the live audio at each moment and facial movements of the real anchor who is speaking and obtaining a second parameter about face when the real anchor is speaking in the live audio at the corresponding moment;
obtaining a fusion parameter by fusing the first parameter and the second parameter;
obtaining a reconstructed image by reconstructing the real anchor of the first live video according to the fusion parameter and generating the second live video according to the reconstructed image.

17. The non-transitory storage medium according to claim 15, wherein before playing the first response video that replies to the question, the method further comprises:
obtaining a question text of the audience and a preset knowledge base of question-and-answer, wherein the preset knowledge base comprises a plurality of standard questions and a plurality of standard answers corresponding to the plurality of standard questions;
performing a semantic match between the question text and each standard question of the preset knowledge base and determining a target question set;
obtaining a standard answer set with the standard answer corresponding to each target question of the target question set; and
generating a target response of the question text according to the standard answer set and the question text by using a large language model;
generating a human voice response speech of the target response and determining a second response video that is time-aligned with the human voice response speech, and obtaining a first response video comprising the human voice response speech by reconstructing the facial movements of the real-person who is speaking in the live broadcast room in the second response video to correspond to the human voice response speech.

18. The non-transitory storage medium according to claim 17, wherein after performing the semantic match between the question text and each standard question of the preset knowledge base, the method further comprises:
obtaining a manual response from a manual customer service representative to the question text in response that the question text does not match any standard question of the preset knowledge base;
generating a human voice response speech for the manual response;
determining a second response video that is time-aligned with the human voice response speech, and obtaining the first response video containing the human voice response speech by reconstructing the facial movements of the real-person who is speaking in the live broadcast room in the second response video to correspond to the human voice response speech.

19. The non-transitory storage medium according to claim 15, wherein after playing the second live video in the live broadcast room, the method further comprises:
generating a chat text of an audience in the live broadcast room;
determining whether the chat text comprises an inquiry intention by identifying the chat text using a preset intention recognition model;
setting the chat text as the question text in response that the chat text comprising the inquiry intention.

20. The non-transitory storage medium according to claim 15, wherein before obtaining the live broadcast text, the method further comprises:
obtaining a preset sample library of verbal tricks;
generating a first audio-driven live broadcast video based on an opening script of the preset sample library, a second audio-driven live broadcast video based on a welcome script of the preset sample library, a third audio-driven live broadcast video based on a promotional script of the preset sample library, a fourth audio-driven live broadcast video based on a thank-you script of the preset sample library, a fifth audio-driven live broadcast video based on an offline script of the preset sample library.
